(19) United States
(12) Patent Application Publication
(10) Pub. No.: US 2018/0292251 A1
(43) Pub. Date: Oct. 11, 2018

(54) Radiation Emitter Isolation Assembly

(71) Applicant: Mustang Sampling LLC, Ravenswood, WV (US)

(72) Inventors: Walter F. Gerhold, Dallas, NC (US); Austin Hill, Troutman, NC (US)

(73) Assignee: Mustang Sampling LLC, Ravenswood, WV (US)

(21) Appl. No.: 15/904,005

(22) Filed: Feb. 23, 2018

Related U.S. Application Data
(60) Provisional application No. 62/484,006, filed on Apr. 11, 2017.

(51) Int. Cl. G01F 23/284; G01S 13/38; G01S 13/88; G01S 7/00; H01Q 1/22; H01Q 13/02

(52) U.S. Cl. CPC G01F 23/284; G01S 13/38; H01Q 13/0275; G01S 7/003; H01Q 1/225; G01S 13/88

(57) ABSTRACT

An anti-fouling, radiation emitter isolation assembly includes an adapter element mounted to a fixed port at the top of a leachate tank. A radiation emitter/detector is further mounted to the adapter element for transmitting radiation through the fixed port to determine a fluid level. The adapter element incorporates an isolation valve that when opened provides an unobstructed window through the fixed port for the transmitted radiation and when closed isolates said radiation emitter/detector from the fixed port. In particular, selectively isolating the radiation emitter/detector from the interior of the tank permits removal of the radiation emitter/detector from the adapter element without requiring a shutdown of leachate tank system operations.

### FIELD OF INVENTION

The invention relates to an improvement in the field of fluid level measurement assemblies having a radiation emitter for analytic measurement of fluid in a container. More particularly, the invention relates to an anti-fouling emitter assembly in which a radiation emitter, such as a radar, sonar, laser, or other wave-energy emitting rangefinder, is selectively isolatable from an unclean, interior environment of a leachate tank and removable for maintenance without requiring system shutdown.

### BACKGROUND OF THE INVENTION

Some leachate tank fluid level detection systems rely on the use of guided-wave radar level detectors typically mounted at the top of a leachate tank. These detectors send radar pulses down a probe extending into the contents of the tank. A point of discontinuity exists along the probe where the air in the tank meets the fluid surface. The discontinuity causes the pulse to reflect back up the probe to the detector. The tank level detection system computes a distance to the fluid surface by calculating an elapsed time between emission and detection of the pulse. The system then translates that distance into a leachate tank fluid level measurement.

In the case of “dirty” landfill gas, however, guided-wave type radar detection is readily subject to fouling by agglomeration of constituents such as dispersed dirty condensates in the form of atomized droplets comprising any of water, carbon dioxide, oxides, hydrocarbons, sulfuric and sulfurous compounds, silicones, metals, etc. Although these dirty condensates usually assume a liquid droplet form and fall from a landfill gas stream to collect at the bottom of the leachate tank, some condensates atomize and disperse within the tank to agglomerate on interior structures, as for example, radiation emitters, detectors, probes, and related equipment.

A fouled radiation emitter, such as a radar measurement device, compromises the accuracy of tank level measurements required for operational control of the system. False fluid level detection readings prevent the generation/propagation of signals necessary for proper system control, for example, draining excess fluid from the leachate tank. In addition, failure to shutdown or terminate operation of a leachate tank pump in the absence of any leachate liquid (i.e., dry running the pump) often causes damage to the pump leading to system shutdown in order to perform the necessary repairs.

Accordingly, there is a need for a radiation emitter isolation assembly that minimizes problems associated with fouled emitter/detector equipment caused by the agglomeration of condensates on or near the assembly/equipment. Specifically, it would be desirable to develop a radiation emitter assembly that isolates or shields the radiation emitter from the “dirty” environment of a container to permit maintenance of the radiation emitter during operational use of the system and to reduce the frequency of required system shutdowns.

### SUMMARY OF THE INVENTION

It is an object of the present invention to overcome problems associated with existing radiation emitters used in leachate tank environments.

Another object of the invention is to provide a novel radiation emitter assembly for isolating a radiation emitter from the interior environment of a leachate container.

A further object of the invention is to provide an anti-fouling fluid level measurement system.

Still another object of the invention is to provide a radiation emitter assembly that facilitates radiation emitter maintenance without requiring system shutdown.

Yet another object of the invention is to improve maintenance safety during radiation emitter removal from the radiation emitter assembly.

These and other objects are satisfied by an assembly for a radiation emitter for transmitting radiation to measure a fluid level in a container through a fixed port providing an opening into the container, comprising: an adapter element having a first end and a second end, said adapter element being securely mounted to the fixed port of the container at said first end and releasably secured to the radiation emitter at said second end; an isolation valve incorporated in said adapter element, said isolation valve capable of movement between a first open position and a second closed position; and a valve motive member connected to said isolation valve for moving said isolation valve between said first open position and said second closed position, wherein said first open position provides an unobstructed window through the fixed port for the transmitted radiation from the radiation emitter, and wherein said second closed position isolates the radiation emitter from the fixed port.

The foregoing and still other objects are satisfied by a method of using an assembly for a radiation emitter according to the foregoing, comprising the step of: isolating the radiation emitter from the container by moving said isolation valve into said second closed position.

The foregoing and still other objects are satisfied by a system for measuring and controlling a fluid level in a container including a fixed port providing an opening into the container, comprising: a radiation emitter-detector unit for transmitting and receiving radiation to measure the fluid level in the container through the fixed port; an adapter element having a first end and a second end, said adapter element being securely mounted to the fixed port at said first end and removably secured to said radiation emitter-detector unit at said second end; an isolation valve capable of movement between a first open position and a second closed position, said isolation valve being incorporated in said adapter element to selectively isolate the radiation emitter-detector unit from the fixed port; a control unit associated with the radiation emitter-detector unit, said radiation emitter-detector unit generating a first signal communicated to said control unit, said first signal corresponding to the fluid level in the container, said control unit generating a second signal upon detection of the fluid level exceeding a predetermined threshold; and a pump in signal communication with said control unit, said pump being actuated by said second signal from said control unit to reduce the fluid level in the container.

The foregoing and still other objects are satisfied by a method of using a system including a radiation emitter, a radiation detector, an isolation valve, a control unit, and a pump for controlling a fluid level in a container, where said container incorporates a fixed mounting port, and where said isolation valve is capable of movement between a first open position providing an unobstructed window through the fixed mounting port for radiation from the radiation emitter and a second closed position isolating the radiation emitter from the fixed mounting port, comprising the steps of: transmitting the radiation from the radiation emitter through the fixed mounting port to measure the fluid level in the container when said isolation valve is in said first open position; receiving reflected radiation by the radiation detector; transmitting a first signal corresponding to the fluid level from the radiation detector to the control unit; transmitting a second signal from the control unit to the pump when the fluid level exceeds a first predetermined threshold; actuating the pump by said second signal to reduce the fluid level in the container; and selectively isolating the radiation emitter from the container by moving the isolation valve into said second closed position.

In saturated landfill gas operations it is common for leachate to accrue around landfill sites due to water permeation, which in turn accelerates decomposition of materials held within solids. Leachate tanks are commonly used to collect hazardous vapor gas condensates resulting from landfill gas operations. In order for the system to remain in proper operational order, however, a fluid level in the leachate tank needs to be properly monitored and controlled to avoid dry running an associated pump.

Thus, in an assembly embodiment the present invention contemplates a maintenance friendly radiation emitter assembly combining an adapter element with a radiation emitter, such as an ultrasonic/radar unit or other rangefinder device, that is both isolatable and shielded from the undesirable effects of atomized constituents within leachate tanks. The radiation emitter is preferably a through-air radar-based device capable of monitoring a leachate tank fluid level. The non-contacting nature of an ultrasonic/radar emitter is desirable in fluid level measurement applications because it provides for separation from the leachate tank interior in contrast to a fluid-contacting counterpart device (e.g., invasive guided-wave radar level detectors). By locating the radiation emitter equipment spaced from the interior of the leachate tank the potential for fouling and concomitant loss of control of the fluid level is minimized.

The assembly of the present invention includes an adapter element mounted on a container attachment member. The adapter element is affixed to the upper portion of the container attachment member, which itself establishes a feedthrough to the lower portion of the attachment member port at the top of the leachate tank. The adapter element incorporates an isolation valve, such as a manually operated ball-valve, cooperatively dimensioned to permit selectively sealing the adapter element feedthrough to isolate the radiation emitter from the interior environment of the leachate thank. This facility thereby permits system operations to continue even during removal and maintenance of the radiation emitter from the adapter element.

In certain embodiments, the present invention further includes a tubular non-contacting unguided wave element, such as condensation resistant horn/cone, associated with the radiation emitter to reduce leachate constituent deposits on or around the radiation emitter. In short, use of a condensation resistant horn/cone associated with a radiation emitter shields the emission source and enhances sensing and control of leachate fluid level in the tank. This, in turn, minimizes the potential for failure and/or operational disruption occasioned by repair or replacement of a radiation emitter while avoiding failure of a leachate pump as a result, for example, of dry running the pump due to inaccurate fluid level detection.

The terminology used herein is for the purpose of describing particular embodiments only and is not intended to be limiting of the invention.

As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

For definitional purposes and as used herein “adapter element” connotes one or more components that may individually or collectively provide direct mounting of a radiation emitter/detector at one end and at the other end to a fixed mounting port of a container (e.g., leachate tank). The connections may be established by way of conventional attachment means such as threading, bolting, flanged connection, compression fitting, etc. Components comprising the adapter element may include, for example, an isolation valve, a valve motive member, a spool, a blowdown valve, a ball valve, etc.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein “container” preferably refers to a leachate tank but may include any type of fluid containing device including, but not limited to, pipelines, fluid transport vehicles, vessels, drums, reservoirs, and the like.

In the detailed description, references to “one embodiment”, “an embodiment”, or “in embodiments” mean that the feature being referred to is included in at least one embodiment of the invention. Moreover, separate references to “one embodiment”, “an embodiment”, or “embodiments” do not necessarily refer to the same embodiment; however, neither are such embodiments mutually exclusive, unless so stated, and except as will be readily apparent to those skilled in the art. Thus, the invention can include any variety of combinations and/or integrations of the embodiments described herein.

For definitional purposes and as used herein “mounting” includes physically contacting, permanently affixed, or releasably connected, as for example, mounting the radiation emitter assembly to the container attachment element. Thus, unless specified, “mounting” is intended to embrace any direct functional connection.

As used herein, and unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

For definitional purposes and as used herein “radiation emitter” connotes a device such as a radar, laser, LiDAR, microwave, ultrasonic, sonar, rangefinder, etc. that emits conventional forms of wave energy to measure a distance. As used herein, “radiation” includes all forms of wave energy, as for example, sound waves, radio waves, laser light, electromagnetic radiation, microwaves, etc.

As used herein “substantially” and other words of degree are relative modifiers intended to indicate permissible variation from the characteristic so modified. It is not intended to be limited to the absolute value or characteristic which it modifies but rather possessing more of the physical or functional characteristic than its opposite, and preferably, approaching or approximating such a physical or functional characteristic.

In the following description, reference is made to the accompanying drawings, which are shown by way of illustration to the specific embodiments in which the invention may be practiced. The following illustrated embodiments are described in sufficient detail to enable those skilled in the art to practice the invention. It is to be understood that other embodiments may be utilized and that structural changes based on presently known structural and/or functional equivalents may be made without departing from the scope of the invention.

### BRIEF DESCRIPTION OF THE DRAWINGS

FIG. 1 illustrates a radiation emitter isolation assembly in accordance with an embodiment of the invention.

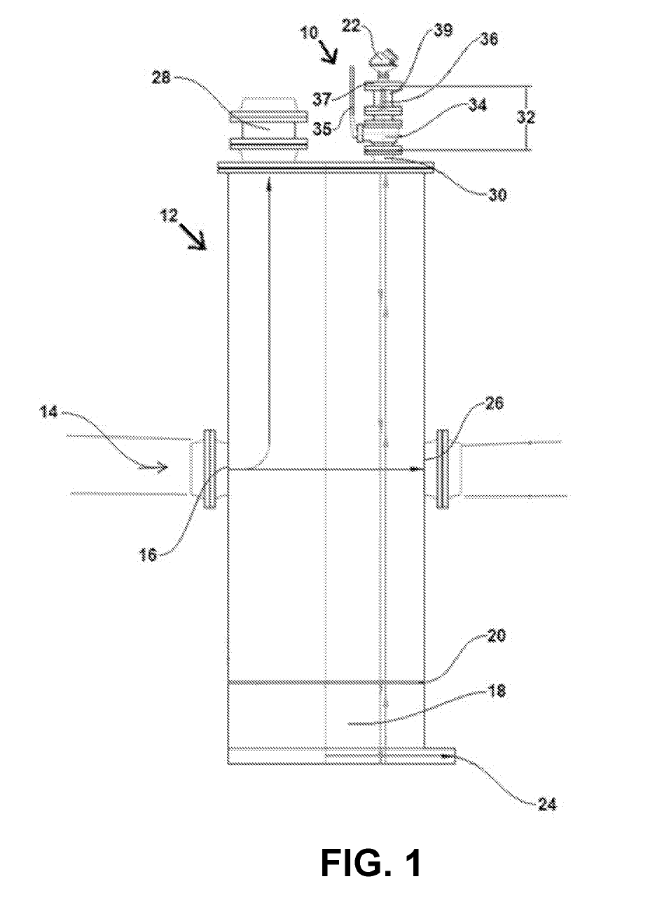

FIG. 2 illustrates a radiation emitter isolation assembly in accordance with an embodiment of the invention.

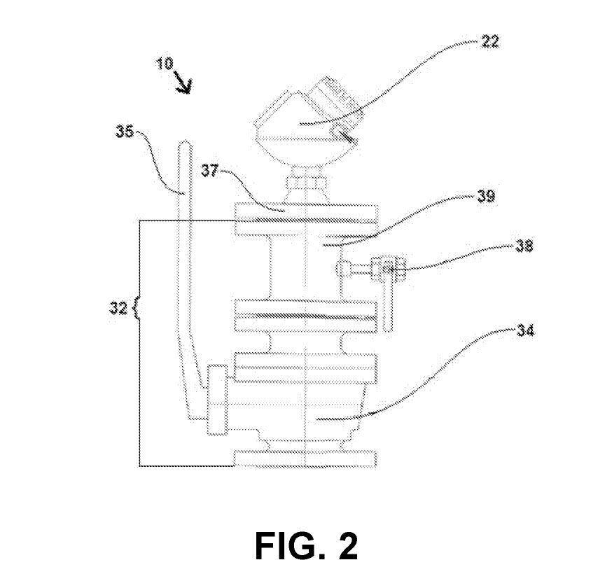

FIG. 3 illustrates a radiation emitter isolation assembly in accordance with an embodiment of the invention.

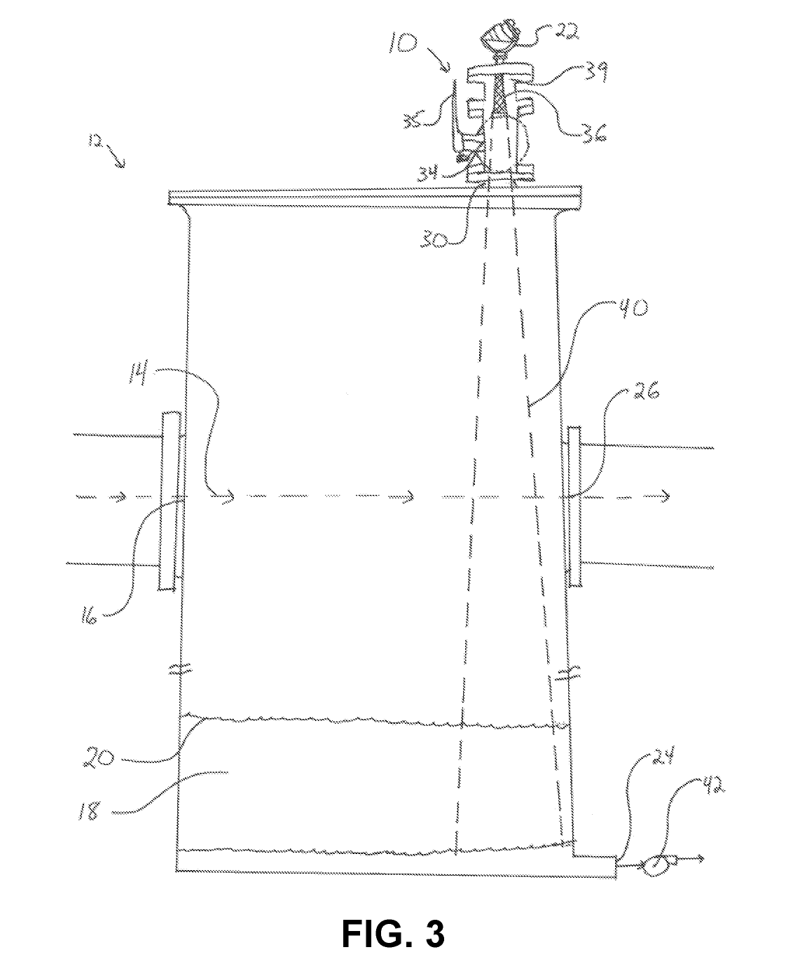

### DETAILED DESCRIPTION OF THE DRAWINGS

The figures illustrate a radiation emitter assembly 10 that is mountable on a container attachment element 30 established at an access port to the interior of a leachate tank 12. Leachate tank 12 is used for the collection of contaminated ground water or condensate 18. In the present invention, saturated vapor gas 14 enters the leachate tank 12 through a vapor input port 16 and exits the leachate tank 12 through a vapor outlet port 26 connected to a downstream takeoff conduit. This saturated landfill gas 14 is of a composition that, for example, may be as high as 50% CH₄, 49% CO₂, and with trace H₂S, Si, and Fe. The incoming vapor stream also may include heavier gaseous hydrocarbons in addition to substantial quantities of nitrogen and water vapor. Typically, as the vapor gas 14 enters the leachate tank 12 the vapor undergoes a phase transition (Joule-Thompson condensation) due to cooling. The resulting condensate falls by gravity to the bottom of the tank 12, thereby forming a pool of the condensate at the bottom of the tank 12. It is desirable to maintain a leachate tank fluid level of approximately 16-20 inches (40.64-50.8 cm) to prevent the leachate pump 42 from becoming damaged due to dry running the pump.

A radiation emitter/detector 22, such as a radar unit, is positioned at the top of the tank 12 and emits radiation (i.e., wave energy) through a fixed mounting port proximate to the top of the leachate tank 12 to determine the fluid level in the leachate tank 12. The radiation emitter/detector 22 comprises a device that operates on principles related to any of radar, laser, LiDAR, sonar, ultrasonic signals, and combinations thereof.

Regardless of the type of radiation emitter/detector 22 that is utilized, a signal is communicated to a control unit from the radiation detector when the radiation detector detects a fluid level in the tank 12 that exceeds a predetermined threshold. The control unit then activates the leachate pump 42 to reduce excess fluid 18 through a fluid outlet port 24 until a desired leachate tank fluid level is reached. The fluid 18 is communicated to a separate location (e.g., a treatment plant) for further storage and processing. When the fluid level is at or below a second predetermined threshold, the control unit transmits a signal to deactivate the pump 42. The signal(s) sent to the control unit and/or pump 42 may be communicated wirelessly or transmitted by a physically connected wire. In some embodiments, the control unit is incorporated in the radiation emitter assembly 10, as for example within the radiation emitter/detector unit 22.

Residual vapor gas 14 remaining in the leachate tank 12 following the condensation process is relieved through the vapor outlet port 26. These vapor gas constituents are also collected and subject to further environmental and system processing. A flow bypass is likewise provided to vent vapor gas 14 through a butterfly valve 28 positioned at the top of the leachate tank 12.

The radiation emitter assembly 10 comprises a radiation emitter/detector unit 22 that is removably secured to an adapter element 32 by a radiation emitter attaching member 37. The adapter element 32 further comprises an isolation valve 34 connected to a valve motive member 35 for opening and closing the isolation valve 34. In some embodiments, the isolation valve 34 is a manually operated 4″ ANSI 150 full port ball valve. However, any operationally functional sealing mechanism, for example electrically actuated/automated shutoff valves, used to isolate the radiation emitter/detector 22 from the interior environment of the tank 12 is contemplated by the invention. In particular, the isolation valve 34 provides isolation of the radiation emitter/detector 22 from hazardous/pressurized vapor gas 14 contained within the tank 12. This allows the radiation emitter/detector 22 to be removed from the adapter element 32 without having to initiate a larger plant or system shutdown.

The adapter element 32 includes a tubular member preferably configured as a spool 39. The tubular member surrounds an elongated, non-contacting, unguided wave element, for example a condensation resistant horn/cone antenna 36, to reduce leachate constituent build up on or around the radiation emitter/detector 22. The spool 39 likewise provides the advantage of separating the radiation emitter/detector 22 from the isolation valve 34 to thereby position the horn/cone antenna 36 above the isolation valve 34 so that the isolation valve 34 can be closed/sealed without being blocked internally by the horn/cone antenna 36.

In addition, the spool 39 preferably incorporates a manually operated blowdown valve 38 provided as a safety feature to depressurize the interior of the spool 39 after the isolation valve 34 is closed. Opening the blowdown valve 38 prior to removing the radiation emitter/detector 22 ensures that the isolation valve 34 is properly sealed and that it is not leaking hazardous gases into the adapter element 32, or more specifically, into the spool interior. The blowdown valve 38 used in some embodiments of the invention is a ¼″ BONOMI 700LL ball valve.

The radiation emitter/detector 22 mounted to the adapter element 32 by the radiation emitter attaching member 37 is preferably a Rosemount Model 5402 ultrasonic level transmitter having a 5.9″ antenna cone and capable of accurate fluid level measurement even when the pooled fluid 18 comprises a turbulent fluid level 20, for example, at the upper ½ inch (1.27 cm) of the pooled fluid 18. In embodiments, the radiation emitter/detector 22 is a high frequency, non-contacting radar having a line power signal output of 4-20 mA/W with HART communication. In addition to measuring fluid level, some embodiments include a radiation emitter/detector 22 having an antenna that is able to make solids measurements. Preferably, the passageway extending through the adapter element 32 is machined/honed to provide an unobstructed passage for emitted radiation with minimal reflectance or interference.

A radiation emitter beam angle 40 is directed from the radiation emitter through the condensation resistant horn/cone antenna 36. A radiation emitter/detector 22 such as the Rosemount Model 5402 ultrasonic level transmitter is desirable for use with the present invention because it emits a narrow beam angle 40 suitable for mounting on valves, taller nozzles, and small openings. In one embodiment, the beam angle 40 is 9° and is sufficiently narrow to project through a feedthrough in the container attachment element 30 associated with a fixed port in the top of the tank 12.

Although only certain embodiments and variations of the invention have been illustrated in the foregoing specification, it is understood by those skilled in the art that many modifications and embodiments of the invention will come to mind to which the invention pertains, having benefit of the teaching presented in the foregoing description and associated drawings. In particular, the present invention is not limited to applications that pertain only to leachate tanks, but may be used in combination with any type of fluid container, as for example, tanks, pipelines, fluid transport vehicles, vessels, drums, reservoirs, and the like. It is therefore understood that the invention is not limited to the specific embodiments disclosed herein, and that many modifications and other embodiments of the invention are intended to be included within the scope of the invention. Moreover, although specific terms are employed herein, they are used only in a generic and descriptive sense, and not for the purposes of limiting the description of the invention.

What is claimed is:

1. An assembly for a radiation emitter for transmitting radiation to measure a fluid level in a container through a fixed port providing an opening into the container, comprising:
an adapter element having a first end and a second end, said adapter element being securely mounted to the fixed port of the container at said first end and releasably secured to the radiation emitter at said second end;
an isolation valve incorporated in said adapter element, said isolation valve capable of movement between a first open position and a second closed position; and
a valve motive member connected to said isolation valve for moving said isolation valve between said first open position and said second closed position,
wherein said first open position provides an unobstructed window through the fixed port for the transmitted radiation from the radiation emitter, and
wherein said second closed position isolates the radiation emitter from the fixed port.

2. The assembly of claim 1 where the isolation valve is a manually operated ball valve.

3. The assembly of claim 1 where the isolation valve is electrically actuated.

4. The assembly of claim 1 where the radiation emitter is a device selected from the group consisting of radar, laser, LiDAR, microwave, ultrasonic, and sonar, and where the device further comprises a radiation emitter beam angle of 9° or less.

5. The assembly of claim 1 where the adapter element further comprises a spool separating the radiation emitter and the isolation valve.

6. The assembly of claim 5 where the radiation emitter further comprises a conical antenna.

7. The assembly of claim 5 where the radiation emitter further comprises a tubular antenna.

8. The assembly of claim 7 where the spool surrounds the tubular antenna.

9. The assembly of claim 5 where the spool further comprises a second valve to depressurize the adapter element when the isolation valve is in the second closed position.

10. The assembly of claim 9 where the second valve is a manually operated blowdown valve.

11. The assembly of claim 1 where the container is a leachate tank.

12. A method of using an assembly for a radiation emitter according to claim 1, comprising the step of:
isolating the radiation emitter from the container by moving said isolation valve into said second closed position.

13. The method according to claim 12 further comprising the step of depressurizing the adapter element by opening a second valve incorporated in said adapter element.

14. The method according to claim 12 further comprising the steps of:
maintaining system operations of the container; and
removing the radiation emitter from said adapter element.

15. A system for measuring and controlling a fluid level in a container including a fixed port providing an opening into the container, comprising:
a radiation emitter-detector unit for transmitting and receiving radiation to measure the fluid level in the container through the fixed port;
an adapter element having a first end and a second end, said adapter element being securely mounted to the fixed port at said first end and removably secured to said radiation emitter-detector unit at said second end;
an isolation valve capable of movement between a first open position and a second closed position, said isolation valve being incorporated in said adapter element to selectively isolate the radiation emitter-detector unit from the fixed port;
a control unit associated with the radiation emitter-detector unit, said radiation emitter-detector unit generating a first signal communicated to said control unit, said first signal corresponding to the fluid level in the container, said control unit generating a second signal upon detection of the fluid level exceeding a predetermined threshold; and
a pump in signal communication with said control unit, said pump being actuated by said second signal from said control unit to reduce the fluid level in the container.

16. The system according to claim 15 where the control unit is incorporated in the radiation emitter-detector unit.

17. The system according to claim 15 where the isolation valve is at least one of an electrically actuated or manually operated.

18. The system according to claim 15 further comprising a spool separating the radiation emitter-detector unit and the isolation valve, and
a second valve incorporated in said spool capable of movement between the first open position and the second closed position.

19. A method of using a system including a radiation emitter, a radiation detector, an isolation valve, a control unit, and a pump for controlling a fluid level in a container, where said container incorporates a fixed mounting port, and where said isolation valve is capable of movement between a first open position providing an unobstructed window through the fixed mounting port for radiation from the radiation emitter and a second closed position isolating the radiation emitter from the fixed mounting port, comprising the steps of:
transmitting the radiation from the radiation emitter through the fixed mounting port to measure the fluid level in the container when said isolation valve is in said first open position;
receiving reflected radiation by the radiation detector;
transmitting a first signal corresponding to the fluid level from the radiation detector to the control unit;
transmitting a second signal from the control unit to the pump when the fluid level exceeds a first predetermined threshold;
actuating the pump by said second signal to reduce the fluid level in the container; and
selectively isolating the radiation emitter from the container by moving the isolation valve into said second closed position.

20. The method according to claim 19 further comprising the step of deactivating the pump when the fluid level is at or below a second predetermined threshold.
